(19) United States
(12) Patent Application Publication
(10) Pub. No.: US 2025/0335635 A1
(43) Pub. Date: Oct. 30, 2025

(54) COMPUTER SYSTEM AND ACCESS VERIFICATION METHOD

(71) Applicant: Hitachi, Ltd., Tokyo (JP)

(72) Inventors: Chihiro YOSHIDA, Tokyo (JP); Shingo MAEDA, Tokyo (JP)

(73) Assignee: Hitachi, Ltd., Tokyo (JP)

(21) Appl. No.: 19/062,753

(22) Filed: Feb. 25, 2025

(30) Foreign Application Priority Data
Apr. 25, 2024 (JP) 2024-071088

(51) Int. Cl. G06F 21/62

(52) U.S. Cl. CPC G06F 21/6281

(57) ABSTRACT

A computer system includes: an acquisition unit that acquires, from a first computer system, management information to be used for access verification of a resource to be referred to in a job step for which a program is migrated from the first computer system; a change unit that changes the management information acquired by the acquisition unit to management information usable by a second computer system; a storage unit that stores the management information changed by the change unit; and a verification unit that performs, in response to a request for execution of a job step with which the program migrated from the first computer system is associated, the access verification of the resource using the management information of the resource to be referred to in the job step stored in the storage unit.

### BACKGROUND OF THE INVENTION

### 1. Field of the Invention

The present invention generally relates to a technique for access verification to a resource referred to in a job step.

### 2. Description of Related Art

In recent years, in order to take advantage of program assets of a main frame system, the number of users who desire to transfer the program assets of the main frame system to an open system is increased.

In this regard, there is a technique in which a batch operation program executed in a main frame system is divided into program units corresponding to job steps constituting a job, and a program for each job step for which modification or the like is completed is sequentially migrated to an open system (see PTL 1).

### CITATION LIST

### Patent Literature

PTL 1: WO2017/208409

### SUMMARY OF THE INVENTION

In access control of the main frame system, when a program of a job step is executed, access verification of the program is performed. However, during the migration to the open system, management information of the program on an open system side becomes unknown, and the access verification cannot be performed when the program is executed in the open system. In this state, there is a problem that a user who does not originally have an execution authority erroneously executes the job step.

The invention has been made in view of the above points, and an object of the invention is to propose a computer system and the like capable of performing access verification of a resource referred to in a job step in an open system.

In order to solve such problems, the invention provides a computer system in which programs for a plurality of job steps are sequentially migrated from a first computer system to a second computer system different from the first computer system, the first computer system including management information to be used for access verification of a resource to be referred to in each of a plurality of job steps, and when executing any one of the plurality of job steps, configured to perform the access verification of the resource using the management information of the resource to be referred to in the job step, the computer system includes: an acquisition unit configured to acquire, from the first computer system, the management information to be used for the access verification of the resource to be referred to in the job step for which the program is migrated from the first computer system; a change unit configured to change the management information acquired by the acquisition unit into management information usable by the second computer system; a storage unit configured to store the management information changed by the change unit; and a verification unit configured to perform the access verification of the resource using the management information of the resource to be referred to in the job step stored in the storage unit in response to a request for execution of the job step with which the program migrated from the first computer system is associated.

According to the above configuration, for example, since the access verification of the resource referred to in the job step to be executed by the second computer system during the program migration period can be implemented, the confidentiality equivalent to the system environment of the first computer system can be maintained.

According to the invention, it is possible to implement a computer system having high confidentiality during a program migration period. Problems, configurations, and effects other than those described above will become apparent in the following description of embodiments.

### BRIEF DESCRIPTION OF THE DRAWINGS

FIG. 1 is a diagram showing an example of a computer system according to a first embodiment;

FIG. 2 is a diagram showing an example of a hardware structure of an open system according to the first embodiment;

FIG. 3 is a diagram showing an example of management information according to the first embodiment;

FIG. 4 is a diagram showing an example of migration history information according to the first embodiment;

FIG. 5 is a diagram showing an example of access history information according to the first embodiment;

FIG. 6 is a diagram showing an example of program registration processing and program monitoring processing according to the first embodiment;

FIG. 7 is a diagram showing an example of job execution processing according to the first embodiment;

FIG. 8 is a diagram showing an example of job step execution processing according to the first embodiment;

FIG. 9 is a diagram showing an example of access verification processing according to the first embodiment;

FIG. 10 is a diagram showing an example of management information change processing and management information change and monitoring processing according to the first embodiment;

FIG. 11 is a diagram showing an example of history reporter processing according to the first embodiment;

FIG. 12 is a diagram showing an example of the migration history collection processing according to the first embodiment;

FIG. 13 is a diagram showing an example of access history collection processing according to the first embodiment;

FIG. 14 is a diagram showing an example of the management information according to the first embodiment;

FIG. 15 is a diagram showing an example of authority type correspondence information according to the first embodiment;

FIG. 16 is a diagram showing an example of aggregation correspondence information according to the first embodiment;

FIG. 17 is a diagram showing an example of an error code according to the first embodiment;

FIG. 18 is a diagram showing an example of designated items according to the first embodiment; and

FIG. 19 is a diagram showing an example of a history reporter according to the first embodiment.

### DESCRIPTION OF THE INVENTION

### (I) First Embodiment

Hereinafter, an embodiment of the invention will be described in detail. However, the invention is not limited to the embodiment.

In the present embodiment, an open system generates management information to be used in its own system based on management information of a main frame system (hereinafter, a main frame). According to such a configuration, access verification can be performed at the time of execution of a job, and confidentiality equivalent to that of a main frame can be maintained even during migration only by executing a task in the related art. In the present embodiment, the open system is automatically adapted to a function unique to the main frame without an alternative function.

In addition, when job-related programs are being sequentially migrated from the main frame to the open system, if a user wants to change the management information on a main frame side, or if the user wants to organize a user or a user group, it is necessary to check all pieces of related data on an open system side in addition to related data on a main frame side in order to prevent inconsistency with the program or data that has already been migrated.

In this regard, in the present embodiment, addition, change, and deletion of the management information on the main frame side are also reflected (synchronized) on the open system side. During job execution on the open system, a synchronization check is also performed and the job operates according to an option (executable or inexecutable when there is an inconsistency). In the present embodiment, a migration history of the management information, and an access history of jobs and job steps executed by the open system during migration are recorded.

According to the migration history and the access history, it is possible to achieve facilitation of an influence investigation at the time of changing authority, facilitation of an influence investigation at the time of organizing a user and a user group, facilitation of identification of a cause of inconsistency in authority, facilitation of identification of a cause at the time of occurrence of an error, an access concentration sign by analysis of an access frequency, and the like.

Hereinafter, an embodiment of the invention will be described with reference to the drawings. The following description and drawings are examples for illustrating the invention, and are appropriately omitted and simplified for clarity of the description. The invention can be implemented in various other forms. Unless otherwise specified, each component may be single or plural. In the following description, the same elements in the drawings are denoted by the same reference numerals, and the description thereof will be appropriately omitted.

Notations of “first”, “second”, “third”, and the like in the present specification and the like are used to identify the components, and the numbers and the order are not necessarily limited. In addition, a number for identifying a component is used for each context, and the number used in one context does not necessarily indicate the same configuration in another context. In addition, this does not prevent a component identified by a certain number from also having a function of a component identified by another number.

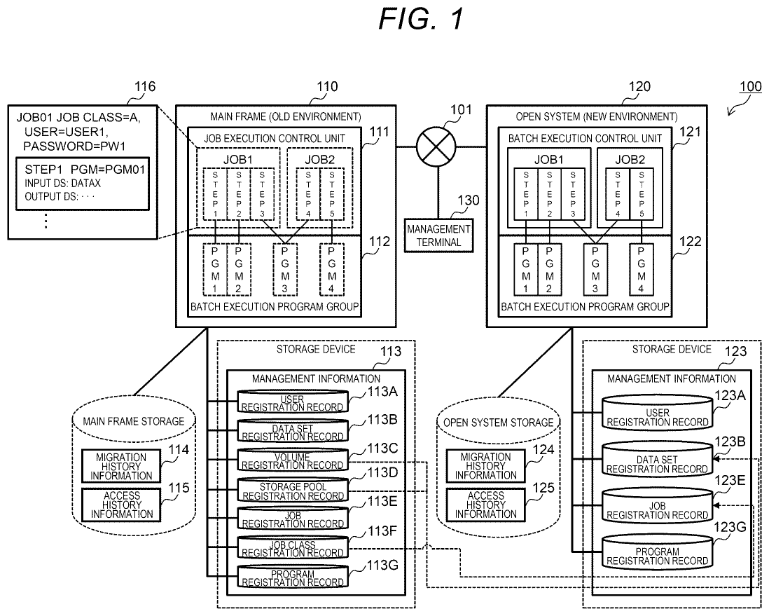

In FIG. 1, reference numeral 100 denotes a computer system according to the first embodiment as a whole.

The computer system 100 includes a main frame 110 which is a program migration source, an open system 120 which is a program migration destination, and a management terminal 130. The main frame 110, the open system 120, and the management terminal 130 are different computer systems and are communicably connected via a network 101. In the computer system 100, for example, a migratable program among a plurality of programs related to business processing (for example, batch processing) executed in the main frame 110 is migrated to the open system 120.

The main frame 110 is a server device, a computer, or the like, and includes a job execution control unit 111 and a batch execution program group 112. The open system 120 is a server device, a computer, a virtual machine, or the like, and includes a batch execution control unit 121 and a batch execution program group 122. The management terminal 130 is a computer, a tablet terminal, or the like including IT system operation management software that integrally performs operation monitoring, infrastructure management, and the like of an IT system of a company. For example, management information 113 included in the main frame 110 and management information 123 included in the open system 120 are managed via the management terminal 130.

More specifically, the main frame 110 is accessibly connected to a storage device that stores the management information 113 and a main frame storage that stores migration history information 114, access history information 115, and the like. The open system 120 is accessibly connected to a storage device that stores the management information 123, and an open system storage that stores migration history information 124, access history information 125, and the like.

The management information 113 is information for managing authority to be used for access verification of resources related to batch processing executed by the main frame 110. The resource related to the batch processing is a resource to be protected in the batch processing, and is a user, a data set, a volume, a storage pool, a job, a job class, a program, or the like. The management information 113 includes a user registration record 113A, a data set registration record 113B, a volume registration record 113C, a storage pool registration record 113D, a job registration record 113E, a job class registration record 113F, and a program registration record 113G.

The management information 123 is information for managing authority to be used for access verification of resources related to batch processing executed by the open system 120. The management information 123 includes a user registration record 123A, a data set registration record 123B, a job registration record 123E, and a program registration record 123G.

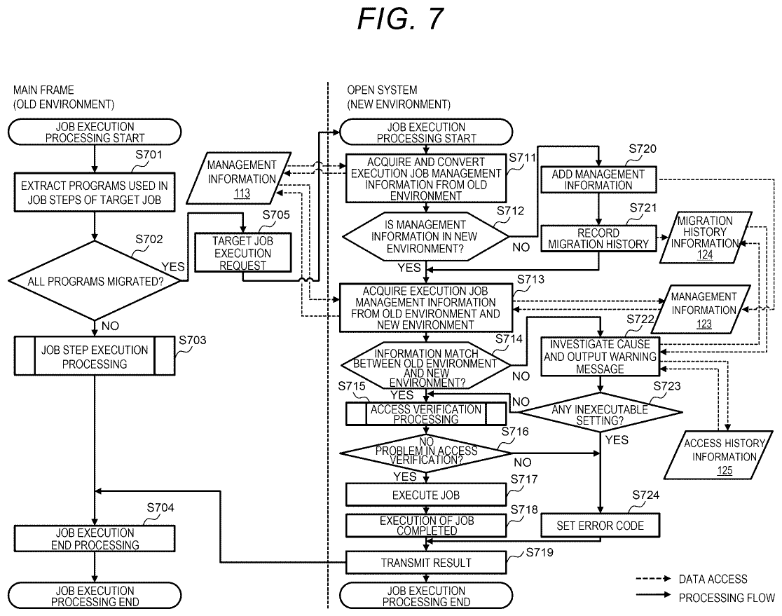

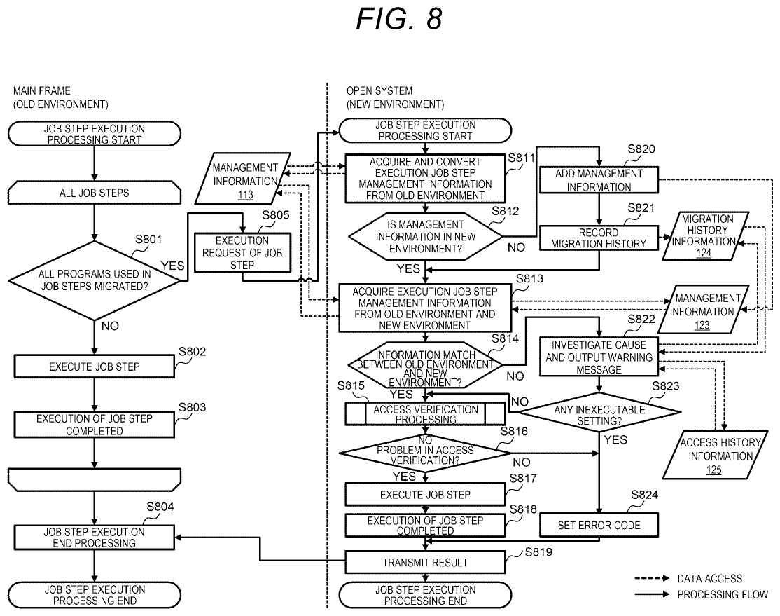

The management information 113 of the main frame 110 is migrated to the management information 123 of the open system 120 at an appropriate timing. Resources for which there is no corresponding function or alternative in the open system 120 are associated with protection information of resources that can be migrated to the open system 120 according to setting contents according to a confidentiality protection method in the main frame 110. For example, the volume registration record 113C and the storage pool registration record 113D are aggregated in the data set registration record 123B. The job class registration record 113F is integrated into the job registration record 123E. Details will be described later with reference to FIGS. 7 and 8.

For example, the job execution control unit 111 executes the batch processing (the batch execution program group 112) according to a job control statement (for example, a job control language (JCL) file 116) in which information such as a program to be executed and a disk to be accessed is described.

The batch processing includes a plurality of jobs (JOB1, JOB2, . . . ) whose execution order is defined, and each job includes one or a plurality of job steps (STEP1, STEP2, . . . ) whose execution order is defined. The “job” is a processing unit in the batch processing, and the “job step” is a processing unit in a job.

One job step is completed by executing one program associated with the job step. One job is completed when each program associated with each job step is sequentially executed in the order of the job steps. One batch processing ends when all jobs are completed. The program may be associated with one job step or a plurality of job steps.

In the present embodiment, the programs necessary for executing the respective job steps of the batch processing are sequentially migrated to the open system 120 in order starting from those that are modified for execution on the open system 120.

For example, the open system 120 registers a migrated program in a library that can be recognized by the batch execution control unit 121 (a batch execution infrastructure). The open system 120 automatically detects the program and requests the main frame 110 to recognize the program as a program executable in a new environment.

When the main frame 110 executes any job of the batch processing, among the job steps constituting the job, the job steps whose corresponding programs are not migrated to the open system 120 are executed in the main frame 110, while the job steps whose corresponding programs are migrated to the open system 120 are executed in the open system 120.

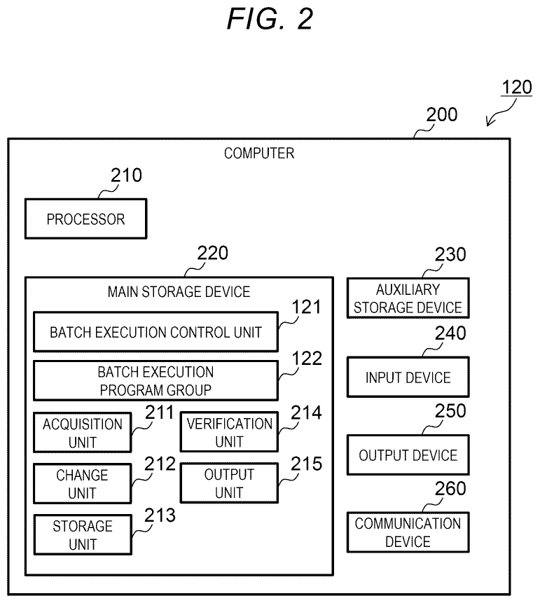

FIG. 2 is a diagram showing an example of a hardware structure (a computer 200) of the open system 120.

The computer 200 includes a processor 210, a main storage device 220, an auxiliary storage device 230, an input device 240, an output device 250, and a communication device 260.

The processor 210 is a device that performs calculation processing. The processor 210 is, for example, a central processing unit (CPU), a micro processing unit (MPU), a graphics processing unit (GPU), or an artificial intelligence (AI) chip.

The main storage device 220 is a device that stores programs, data, and the like. The main storage device 220 is, for example, a read only memory (ROM), a random access memory (RAM), or the like. The ROM is a static random access memory (SRAM), a non volatile RAM (NVRAM), a mask read only memory (ROM), a programmable ROM (PROM), or the like. The RAM is a dynamic random access memory (DRAM) or the like.

The auxiliary storage device 230 is a hard disk drive, a flash memory, a solid state drive (SSD), an optical storage device, or the like. The optical storage device is a compact disc (CD), a digital versatile disc (DVD), or the like. The programs and the data stored in the auxiliary storage device 230 are read into the main storage device 220 as needed.

The input device 240 is a user interface that receives information from a user. Examples of the input device 240 include a keyboard, a mouse, a card reader, a touch panel.

The output device 250 is a user interface that outputs various types of information (a display output, an audio output, a print output, and the like). The output device 250 is, for example, a display device that visualizes various types of information, an audio output device (speaker), and a printing device. The display device is a liquid crystal display (LCD), a graphic card, or the like.

The communication device 260 is a communication interface that communicates with other devices via a communication medium. The communication device 260 is, for example, a network interface card (NIC), a wireless communication module, a universal serial bus (USB) module, or a serial communication module. The communication device 260 can also function as an input device that receives information from another device communicably connected thereto. The communication device 260 can also function as an output device that transmits information to another device communicably connected thereto.

Functions of the computer 200 (the batch execution control unit 121, the batch execution program group 122, an acquisition unit 211, a change unit 212, a storage unit 213, a verification unit 214, an output unit 215, and the like) may be achieved by, for example, the processor 210 reading a program stored in the auxiliary storage device 230 into the main storage device 220 and executing the program (software), may be achieved by hardware such as a dedicated circuit, or may be achieved by a combination of software and hardware. One function of the computer 200 may be divided into a plurality of functions, or a plurality of functions may be integrated into one function. A part of the functions of the computer 200 may be provided as another function or may be included in another function. A part of the functions of the computer 200 may be achieved by another computer capable of communicating with the computer 200. Each component of the hardware of the computer 200 may be one or plural.

The acquisition unit 211 acquires, from the main frame 110, management information to be used for access verification of a resource referred to in a job step in which a program is migrated from the main frame 110. The change unit 212 changes the management information acquired by the acquisition unit 211 to management information usable in the open system 120. The storage unit 213 stores the management information changed by the change unit 212. The verification unit 214, in response to a request to execute a job step associated with a program migrated from the main frame 110, performs the access verification of a resource by using the management information of the resource to be referred to in the job step stored in the storage unit 213. When the output unit 215 receives from the management terminal 130 an instruction for designating a resource and/or a period for which the user needs to check, the output unit 215 extracts the migration history information or the access history information stored in the storage unit 213 according to the instruction, and outputs the extracted information.

In the present embodiment, the management information 123 is read from the storage device and stored in the main storage device 220, and the migration history information 124 and the access history information 125 are read from the open system storage and stored in the main storage device 220. The information of the main storage device 220 and the information of the storage device are synchronized. The information of the main storage device 220 and the information of the open system storage are synchronized.

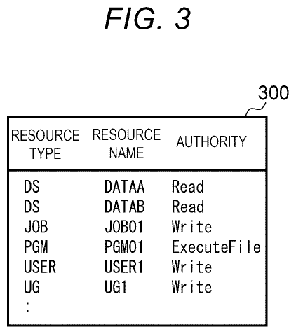

FIG. 3 is a diagram showing an example of the management information 123 (a management information table 300).

The management information table 300 is a table that stores information synchronized with the management information 123 and is a table stored in the main storage device 220. The management information table 300 stores a record including values of a plurality of items indicating authority of a resource related to a job executed by the open system 120.

More specifically, when the open system 120 executes a job, the management information table 300 stores a record in which information of a resource type indicating a type of a resource related to the job, a resource name indicating a name of the resource, and authority indicating authority to permit an operation on the resource are associated with each other. The management information table 300 may include information such as a registered user and a registration date and time.

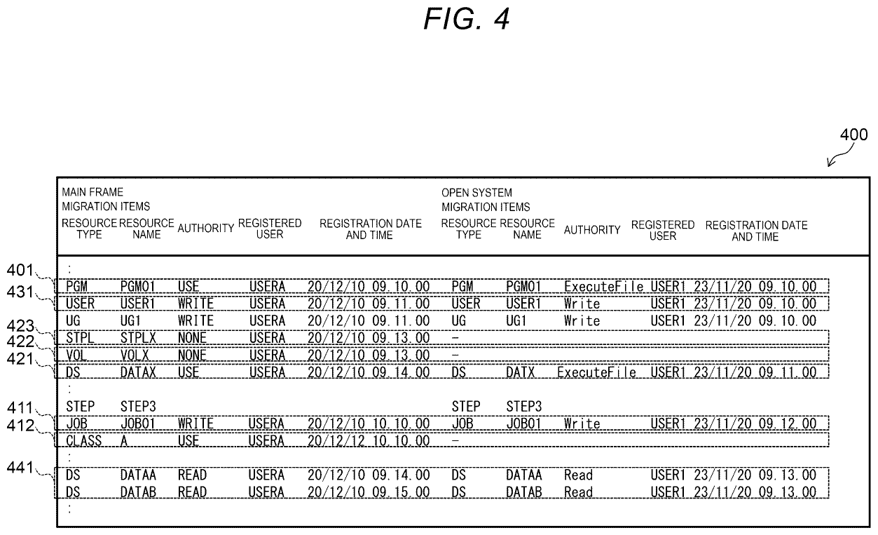

FIG. 4 is a diagram showing an example of the migration history information 124 (a migration history table 400).

The migration history table 400 stores a record including values of a plurality of items indicating a history of migration of management information.

More specifically, the migration history table 400 stores a record in which management information (for example, information indicating authority) of a migration source resource and management information of a migration destination resource are associated with each other. The management information of the migration source resource is information of a resource type indicating a type of the resource in the main frame 110, a resource name indicating a name of the resource, authority to permit an operation on the resource, a registered user indicating a user who registers the authority, and a registration date and time when the authority of the resource is registered. The management information of the migration destination resource is information of a resource type indicating a type of the resource in the open system 120, a resource name indicating a name of the resource, authority to permit an operation on the resource, a registered user indicating a user who registers (migrates) the resource, and a registration date and time when the authority of the resource is registered.

A table that stores information (migration history) acquired from the migration history information 124, that is, a table stored in the main storage device 220 may be similar to the migration history table 400, and thus illustration and description thereof will be omitted.

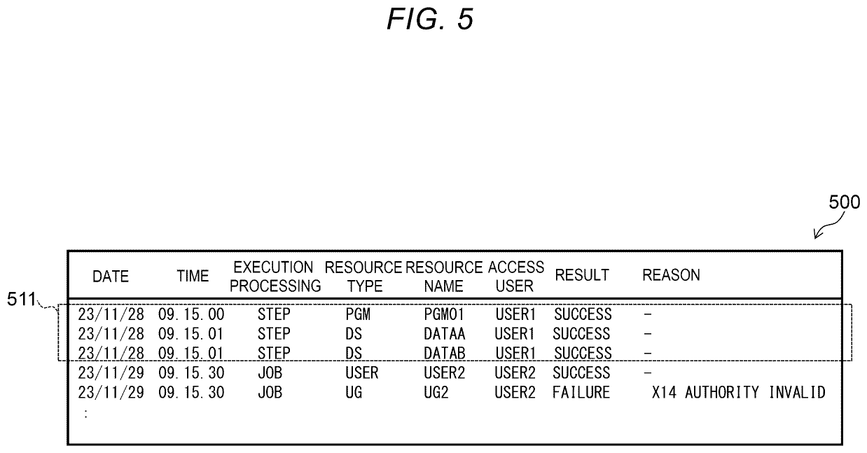

FIG. 5 is a diagram showing an example of the access history information 125 (an access history table 500).

The access history table 500 stores a record including values of a plurality of items indicating a history of access to resources of the open system 120. More specifically, the access history table 500 stores information such as a record in which a date indicating a date of access to a resource of the open system 120, a time indicating a time of access to the resource, execution processing indicating processing of accessing the resource, a resource type indicating a type of the resource, a resource name indicating a name of the resource, an access user indicating a user who accesses the resource, a result indicating a result of access to the resource, and a reason indicating a reason why the access to the resource fails are associated with each other.

A table that stores information (an access history) acquired from the access history information 125, that is, a table stored in the main storage device 220 may be similar to the access history table 500, and thus illustration and description thereof will be omitted.

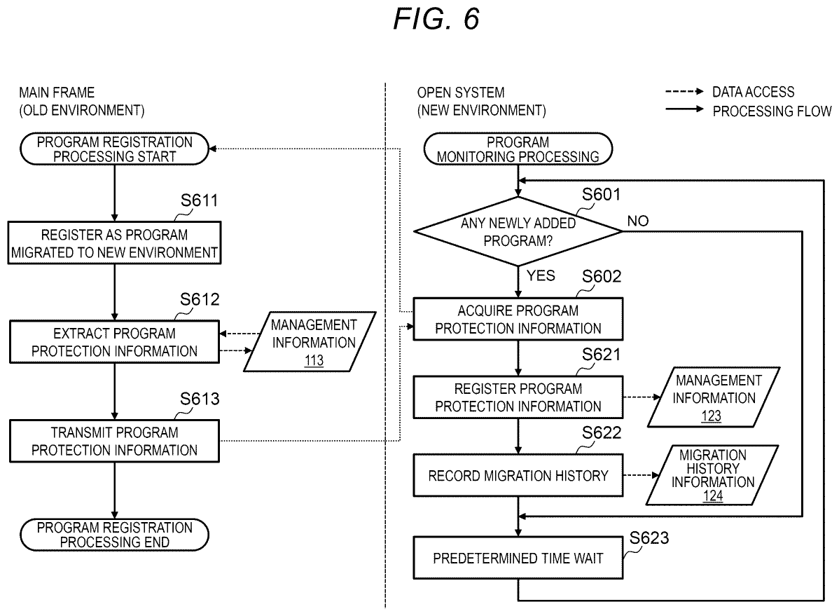

Next, processing in the computer system 100 will be described with reference to FIGS. 6 to 13. First, processing related to the migration of the management information will be described.

FIG. 6 is a diagram showing an example of processing (program registration processing and program monitoring processing) of migrating management information to be used for access verification of a program.

In S601, the open system 120 determines whether there is a newly added program. When the open system 120 determines that there is a newly added program, the processing proceeds to S602, and when the open system 120 determines that there is no newly added program, the processing proceeds to S623.

In S602, the open system 120 acquires, from the main frame 110, management information (program protection information) of the newly added program. For example, the open system 120 transmits, to the main frame 110, information (for example, a program name) of the newly added program.

In S611, based on the information of the program transmitted from the open system 120, the main frame 110 registers the program as a program migrated to a new environment.

In S612, the main frame 110 extracts program protection information from the management information 113.

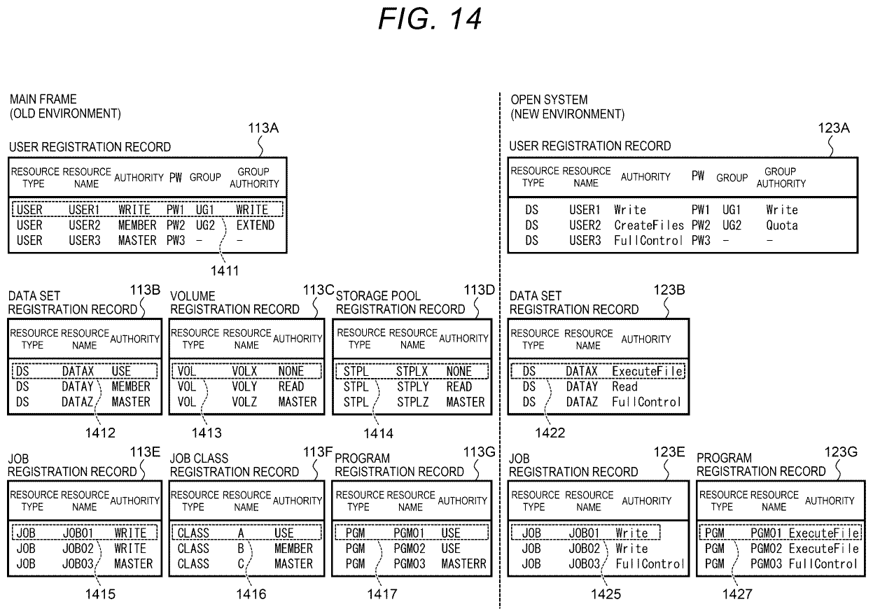

Here, processing of extracting the program protection information will be described with reference to FIG. 14. For example, when a program “PGM01” is migrated, a record 1417 of the program “PGM01” is acquired from the program registration record 113G as the program protection information. The record 1417 includes information of a resource type “PGM”, the resource name “PGM01”, and authority “USE”. Although not shown, the record 1417 may include information such as a registered user and a registration date and time.

In S613, the main frame 110 transmits the program protection information extracted in S612 to the open system 120.

In S621, the open system 120 registers the program protection information transmitted from the main frame 110 in the management information 123.

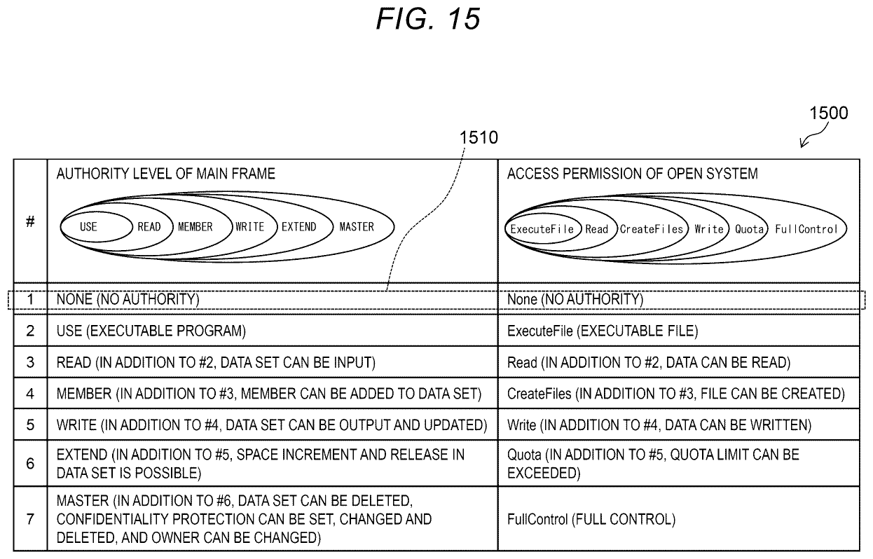

At this time, the open system 120 changes the program protection information to a format (notation) usable in the open system 120 by using an authority type correspondence table 1500 shown in FIG. 15. For example, when the record 1417 is received as the program protection information, the open system 120 changes “USE” indicating the authority in the main frame 110 to “ExecuteFile” indicating the corresponding authority in the open system 120. Then, the open system 120 adds a record 1427 including the information of the resource type “PGM”, the resource name “PGM01”, and the authority “ExecuteFile” to the program registration record 123G. Although not shown, the record 1427 may include information of the registered user and the registration date and time.

In S622, the open system 120 records the migration history of the program protection information in the migration history information 124. For example, a record 401 including the program protection information before the change in the main frame 110 (the record 1417) and the program protection information after the change in the open system 120 (the record 1427) is added to the migration history table 400.

In S623, the open system 120 waits for a predetermined time, and the processing proceeds to S601.

In the above processing, the management information to be used for the access verification of the program is migrated from the main frame 110 to the open system 120. According to the above processing, when executing a program migrated from the main frame 110, the open system 120 can perform the access verification of the program.

FIG. 7 is a diagram showing an example of processing (job execution processing) of migrating the management information to be used for access verification of a job.

In S701, the main frame 110 extracts a program to be used in a job step of a job to be executed (a target job).

In S702, the main frame 110 determines whether all programs extracted in S701 are migrated to the open system 120. When the main frame 110 determines that all programs are migrated, the processing proceeds to S705, and when the main frame 110 determines that at least one program is not migrated, the processing proceeds to S703.

In S703, the main frame 110 performs job step execution processing. The job step execution processing will be described later with reference to FIG. 8.

In S704, the main frame 110 performs job execution end processing, and ends the processing.

In S705, the main frame 110 transmits a target job execution request to the open system 120. For example, the target job execution request includes information to be used for executing the target job (for example, a JCL file 116, information for identifying the JCL file 116, or a resource name of a resource described in the JCL file 116).

In S711, the open system 120 acquires, from the main frame 110 (the old environment), management information to be used for access verification of a resource to be referred to in a job (an execution job) requested to be executed, and performs conversion processing for converting the management information into the format of the open system 120.

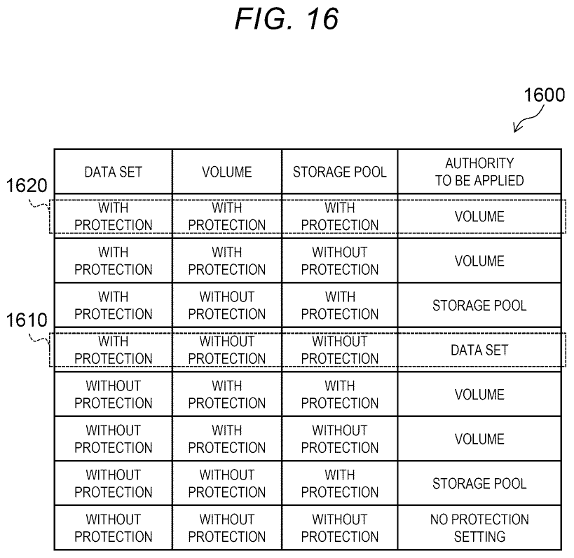

Here, the conversion processing will be described. For example, the open system 120 maintains authority of a user and a program. For jobs and job classes, since there is no alternative for a job class, when the job has no protection setting or the authority is job⊂job class, the open system 120 applies the authority of the job class to the job, and when the authority is job⊇job class, the open system 120 applies the authority of the job as it is. Due to the processing, the authority of the job class and the authority of the job are aggregated (integrated). For a data set, a volume, and a storage pool, the open system 120 aggregates the authority of the data set, the volume, and the storage pool according to an aggregation correspondence table 1600 shown in FIG. 16. Then, the open system 120 changes the authority after the conversion processing to a format usable in the open system 120 by using the authority type correspondence table 1500 shown in FIG. 15.

More specifically, a case in which the open system 120 receives a resource name (for example, a job name “JOB01”, a class name “A”, a user name “USER1”, a job step name “STEP1”, a program name “PGM01”, and a data set name “DATAX”) described in the JCL file 116 will be described as an example. In this case, the open system 120 acquires a record 1411 of the user registration record 113A, a record 1412 of the data set registration record 113B, a record 1413 of the volume registration record 113C of the volume in which the data set with the data set name “DATAX” is stored, a record 1414 of the storage pool registration record 113D of the storage pool to which the volume belongs, a record 1415 of the job registration record 113E, a record 1416 of the job class registration record 113F, and the record 1417 of the program registration record 113G as the management information associated with the resource name.

For the authority of the user, the open system 120 leaves the record 1411 as “WRITE”. For the authority of the data set, since the authority of the data set is “USE” in the record 1412, the authority of the volume is “NONE” in the record 1413, and the authority of the storage pool is “NONE” in the record 1414, the open system 120 aggregates the authority to the authority “USE” of the data set according to a record 1610 of the aggregation correspondence table 1600. For the authority of the job, since the authority of the job is “WRITE” in the record 1415 and the authority of the class is “USE” in the record 1416, the open system 120 determines that the authority is job name⊇job class, and aggregates the authority of the job into “WRITE”. For the authority of the program, the open system 120 leaves the record 1417 as “USE”.

Further, using the authority type correspondence table 1500, the open system 120 changes the format of the authority of the user to “Write”, changes the format of the authority of the data set to “ExecuteFile”, changes the format of the authority of the job to “Write”, and changes the format of the authority of the program to “ExecuteFile”.

In S712, the open system 120 determines whether the management information of the execution job is registered in the management information 123 of the open system 120 (the new environment). For example, the open system 120 refers to the management information 123 and checks whether the management information of the job, the management information of the user, the management information of the data set, and the management information of the program are registered. When the open system 120 determines that the management information of the execution job is registered in the management information 123 in the new environment, the processing proceeds to S713, and when the open system 120 determines that the management information of the execution job is not registered in the management information 123 in the new environment, the processing proceeds to S720.

In S713, the open system 120 acquires management information in the old environment of the execution job and management information in the new environment of the execution job. The management information in the old environment is subjected to the conversion processing similar to that of S711.

In S714, the open system 120 determines whether the management information (the authority) in the old environment of the execution job matches the management information (the authority) in the new environment of the execution job. When the open system 120 determines that the authority in the old environment matches that in the new environment, the processing proceeds to the processing to S715, and when the authority in the old environment does not match that in the new environment, the processing proceeds to S722.

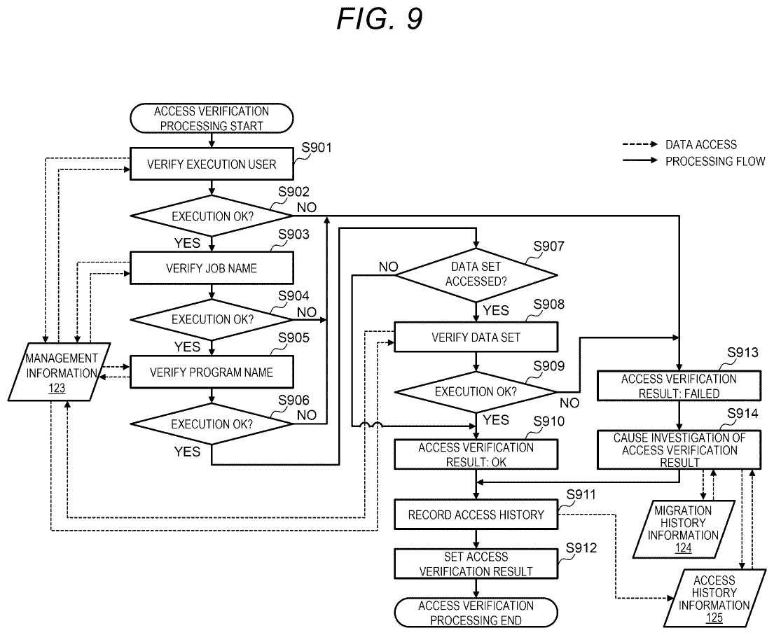

In S715, the open system 120 executes access verification processing. In the access verification processing, access verification of an execution job and access verification of job steps included in the execution job are performed. The access verification processing will be described later with reference to FIG. 9.

In S716, the open system 120 determines whether there is a problem in the access verification. When the open system 120 determines that there is no problem in the access verification, the processing proceeds to S717, and when the open system 120 determines that there is a problem in the access verification, the processing proceeds to S724.

In S717, the open system 120 executes a job (all job steps included in the job).

In S718, the open system 120 generates a result indicating that the execution of the job is completed.

In S719, the open system 120 transmits a result related to the execution of the job to the main frame 110, and ends the processing.

In S720, the open system 120 adds to the management information 123 management information that is not registered in the new environment among the management information converted in S711.

In S721, the open system 120 records the migration history indicating that the management information is migrated in the migration history information 124, and the processing proceeds to S713. For example, when the open system 120 executes the job with the job name “JOB01” for the first time after the migration, when the management information of the job is added to the management information 123, the open system 120 adds, to the migration history table 400, a record (a record 411) including the management information before the change of the job in the main frame 110 (the record 1415) and the management information after the change of the job in the open system 120 (the record 1425). At this time, the open system 120 adds, to the migration history table 400, a record (a record 412) including the management information of the aggregated job class (the record 1416).

In S722, the open system 120 investigates a cause based on the migration history information 124 and the access history information 125, and outputs a warning message.

Here, when the authority is changed or unintentionally changed by an operation that does not remain in the history in the new environment, the information of the authority of the user “USER1” may not match between the old environment and the new environment. For example, when the authority of the “USER1” in the old environment is “WRITE”, the authority of the “USER1” in the new environment is “Read”, and the authority in the old environment is different from that in the new environment, the open system 120 searches for a record 431 of the latest migration history for the “USER1”. According to the record 431 of the migration history, the authority of the “USER1” is migrated with “WRITE” in the old environment and “Write” in the new environment, but is now “Read” in the new environment. Since the open system 120 cannot further investigate the cause from the migration history information 124 as to any timing inconsistency occurs, the investigation of the migration history ends here, and the following message is displayed on the management terminal 130.
>AUTHORITY MISMATCH:USER1
>USER USER1 WRITE USERA 20/12/10 09.11.00 USER USER1 Write USER1 23/11/20 09.10.00

Next, the open system 120 checks the latest access history of the “USER1”. The open system 120 extracts a record 511 of the access history of the resource accessed by the “USER1” and the record 401 and a record 441 of the migration history of the resource, and displays the records together on the management terminal 130 as follows.
>23/11/28 09.15.00 STEP PGM PGM01 USER1 SUCCESS—
>23/11/28 09.15.01 STEP DS DATAA USER1 SUCCESS—
>23/11/28 09.15.01 STEP DS DATAB USER1 SUCCESS—
>PGM PGM01 USE USERA 20/12/10 09.12.00 PGM PGM01 ExecuteFile USER1 23/11/20 09.10.00
>DS DATAA READ USERA 20/12/10 09.14.00 DS DATAA Read USER1 23/11/20 09.13.00
>DS DATAB READ USERA 20/12/10 09.15.00 DS DATAB Read USER1 23/11/20 09.13.00

According to the above information, the user can narrow down a period in which the authority in the new environment of the “USER1” is changed and investigate a system log or the like. When the new environment “Read” is correct, for example, the user performs synchronization processing so that the authority “Read” in the new environment is reflected, and matches the information between the old environment and the new environment, thereby preventing an error from being output in the future. Additionally, since the processing of the program is the same as that of the user, the description thereof will be omitted. Regarding the data set and the job, since the authority is converted when the management information is transferred, there may be a “mismatch but correct” state. This state is checked in S714, and the processing proceeds to S722.

In S723, the open system 120 determines whether there is an inexecutable setting. When the open system 120 determines that there is an inexecutable setting, the processing proceeds to S724, and when the open system 120 determines that there is no inexecutable setting, the processing proceeds to S715. For example, when the authority of the user authority is insufficient, an error occurs in the access verification processing even if there is no inexecutable setting.

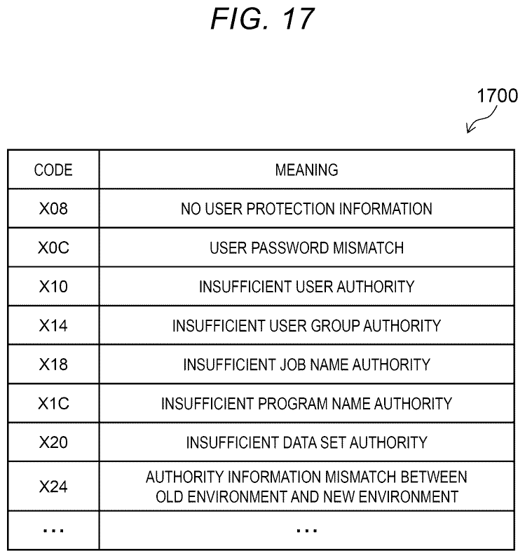

In S724, the open system 120 sets an error code, and the processing proceeds to S719. For example, when the result of the access verification is failed, an error code in FIG. 17 indicating the result is set. More specifically, when it is determined as NO in the determination of S714 (when the result of the access verification is “the authority information does not match between the old environment and the new environment”), the open system 120 generates “>FAILED-X24 AUTHORITY MISMATCH:USER1” as a result of setting the error code “X24” corresponding to “the authority information does not match between the old environment and the new environment”, and the processing proceeds to S719.

FIG. 8 is a diagram showing an example of the job step execution processing. In the job step execution processing, the main frame 110 performs the processing in steps S801 to S803 for all job steps.

In S801, the main frame 110 determines whether all programs to be used in job steps of a processing target are migrated. When the main frame 110 determines that all the programs are migrated, the processing proceeds to S805, and when the main frame 110 determines that at least one program is not migrated, the processing proceeds to S802.

In S802, the main frame 110 executes the job step of the processing target. In the present embodiment, the main frame 110 includes the management information to be used for the access verification of a resource referred to in each of a plurality of job steps. When any one job step of the plurality of job steps is executed, the main frame 110 performs the access verification of the resource by using the management information of the resource referred to in the job step. For example, the main frame 110 performs the access verification of the program using the management information of the program associated with the job step.

In S803, the main frame 110 generates a result indicating that the execution of the job step of the processing target is completed.

In S804, the main frame 110 performs job step execution end processing, and ends the processing.

In S805, the main frame 110 transmits a job step execution request of the processing target to the open system 120. For example, the execution request includes information to be used to execute the job step of the processing target (for example, the JCL file 116, information for identifying the JCL file 116, or a resource name of a resource described in the JCL file 116).

In S811, the open system 120 acquires, from the main frame 110 (the old environment), the management information of the resource referred to in the job step (the execution job step) requested to be executed, and performs conversion processing for converting the management information into the format of the open system 120. The conversion processing is the same as that in S711, and a description thereof will be omitted.

In S812, the open system 120 determines whether the management information of the execution job step is registered in the management information 123 of the open system 120 (the new environment). When the open system 120 determines that the management information of the execution job step is registered in the management information 123 in the new environment, the processing proceeds to S813, and when the open system 120 determines that the management information of the execution job step is not registered in the management information 123 in the new environment, the processing proceeds to S820. Here, the open system 120 checks whether the management information of the user, the management information of the data set, and the management information of the program are registered. Whether the management information of the job is registered is checked at the time of job execution processing.

In S813, the open system 120 acquires the management information in the old environment of the execution job step and the management information in the new environment of the execution job step. The management information in the old environment of the execution job step is subjected to the conversion processing similar to that in S811.

In S814, the open system 120 determines whether the management information (authority) in the old environment of the execution job matches the management information (authority) in the new environment of the execution job. When the open system 120 determines that the authority in the old environment matches that in the new environment, the processing proceeds to the processing to S815, and when the authority in the old environment does not match that in the new environment, the processing proceeds to S822.

In S815, the open system 120 executes access verification processing. In the access verification processing, access verification of a resource to be referred to in the execution job step is performed. The access verification processing will be described later with reference to FIG. 9.

In S816, the open system 120 determines whether there is a problem in the access verification. When the open system 120 determines that there is no problem in the access verification, the processing proceeds to S817, and when the open system 120 determines that there is a problem in the access verification, the processing proceeds to S824.

In S817, the open system 120 executes a job step.

In S818, the open system 120 generates a result indicating that the execution of the job step is completed.

In S819, the open system 120 transmits the result of the execution of the job step to the main frame 110, and ends the processing.

In S820, the open system 120 adds to the management information 123 management information that is not registered in the new environment among the management information of the job step determined in S812.

In S821, the open system 120 records the migration history of the management information added to the new environment in the migration history information 124, and the processing proceeds to S813. For example, when the open system 120 adds the management information (the record 1422) of the data set “DATAX” to the management information 123, the open system 120 adds, to the migration history table 400, a record (a record 421) including the management information before the change of the data set in the main frame 110 (the record 1412) and the management information after the change of the data set in the open system 120 (the record 1422). At this time, the open system 120 adds, to the migration history table 400, a record (a record 422) including the management information (the record 1413) of the aggregated volume and a record (a record 423) including the management information (the record 1414) of the aggregated storage pool.

In S822, the open system 120 investigates a cause based on the migration history information 124 and the access history information 125, and outputs a warning message. The processing in S822 is similar to the processing in S722, and a detailed description thereof will be omitted.

In S823, the open system 120 determines whether there is an inexecutable setting. When the open system 120 determines that there is an inexecutable setting, the processing proceeds to S824, and when the open system 120 determines that there is no inexecutable setting, the processing proceeds to S815.

In S824, the open system 120 sets an error code, and the processing proceeds to S819. The processing in S824 is similar to the processing in S724, and a detailed description thereof will be omitted.

FIG. 9 is a diagram showing an example of the access verification processing.

In S901, the open system 120 verifies a user (an execution user) who instructs execution of a job. For example, the open system 120 acquires the management information of the user having a user name described in a job control statement from the management information 123, and determines that the execution is failed when the authority of the execution user is “None”. For example, when a user name and a password input by the execution user are different from a user name and a password described in the job control statement, the open system 120 determines that the execution is failed.

In S902, the open system 120 determines whether the verification of the execution user is execution OK. When the open system 120 determines that the verification is execution OK, the processing proceeds to S903, and when the open system 120 determines that the verification is not execution OK (execution failed), the processing proceeds to S913.

In S903, the open system 120 verifies the job name. For example, the open system 120 acquires the management information of the job having the job name described in the job control statement from the management information 123, and when the authority of the execution user is the same as the authority of the job or when the authority of the execution user is stronger (wider) than the authority of the job, the open system 120 determines that the verification is execution OK. When the access verification processing is called from the job step execution processing, the job name is not verified (the processing of S903 and S904 are omitted, and the processing proceeds to S905).

In S904, the open system 120 determines whether the verification of the job name is execution OK. When the open system 120 determines that the verification is execution OK, the processing proceeds to S905, and when the open system 120 determines that the verification is not execution OK, the processing proceeds to S913.

In S905, the open system 120 verifies the program name. For example, the open system 120 acquires the management information of the program having the program name described in the job control statement from the management information 123, and when the authority of the execution user is the same as the authority of the program, or when the authority of the execution user is stronger than the authority of the program, the open system 120 determines that the verification is execution OK. Here, all program names described in the job control statement are verified.

In S906, the open system 120 determines whether the verification of the program name is execution OK. When the open system 120 determines that the verification is execution OK, the processing proceeds to S907, and when the open system 120 determines that the verification is not execution OK, the processing proceeds to S913.

In S907, the open system 120 determines whether a data set is accessed (data input and output is designated in the job step of the job control statement). When the open system 120 determines that the data set is accessed, the processing proceeds to S908, and when the open system 120 determines that the data set is not accessed, the processing proceeds to S910.

In S908, the open system 120 verifies the data set. For example, the open system 120 acquires, from the management information 123, the management information of the data set of the data set name described in the job control statement, and when the authority of the execution user is the same as the authority of the data set, or when the authority of the execution user is stronger than the authority of the data set, the open system 120 determines that the verification is execution OK. Here, all data sets described in the job control statement are verified.

In S909, the open system 120 determines whether the verification of the data set is execution OK. When the open system 120 determines that the verification is execution OK, the processing proceeds to S910, and when the open system 120 determines that the verification is not execution OK, the processing proceeds to S913.

In S910, the open system 120 sets the access verification result to “OK” indicating that there is no problem in the access verification.

In S911, the open system 120 records the access history in the access history information 125 for each verified resource.

In S912, the open system 120 sets an access verification result, and ends the processing. In the access verification result, “OK” or “failed” and an error code described later are set.

In S913, the open system 120 sets the access verification result to “failed” indicating that there is a problem in the access verification.

In S914, the open system 120 performs cause investigation for the access verification result, and the processing proceeds to S911. The open system 120 identifies an error code for the verification that is determined as execution failed. For example, when it is determined that the verification is not execution OK in the determination of S909, the open system 120 determines that the authority of the data set is insufficient, and identifies an error code “X20” shown in FIG. 17.

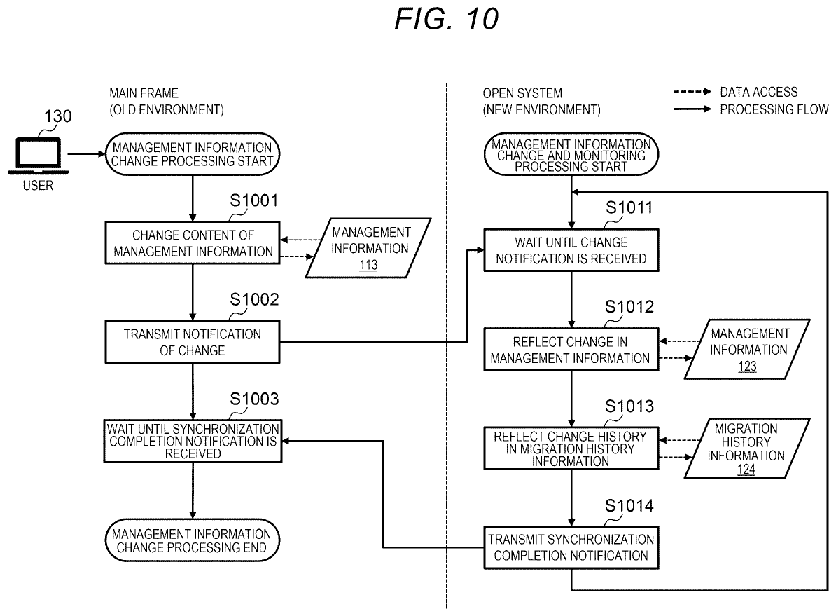

FIG. 10 is a diagram showing an example of processing for synchronizing the management information 113 and the management information 123 (management information change processing and management information change and monitoring processing). The processing of synchronizing the management information is performed on the resource for which the migration of the management information is completed.

In S1001, the main frame 110 changes the content of the management information 113 according to a management information change operation performed by the management terminal 130.

In S1002, the main frame 110 transmits a notification of the change of the management information to the open system 120. For example, when the management information of the resource for which the migration is completed is changed, the main frame 110 transmits, to the open system 120, the management information before the change and the management information after the change.

In S1003, the main frame 110 waits until a synchronization completion notification is received, and when a synchronization completion notification is received, the processing ends.

In S1011, the open system 120 waits until a change notification of the management information is received.

In S1012, the open system 120 reflects the change in the management information 123.

In S1013, the open system 120 reflects a change history in the migration history information 124 (for example, adds a record including the management information before the change and the management information after the change to the migration history table 400).

In S1014, the open system 120 transmits a synchronization completion notification to the main frame 110, and the processing proceeds to S1011.

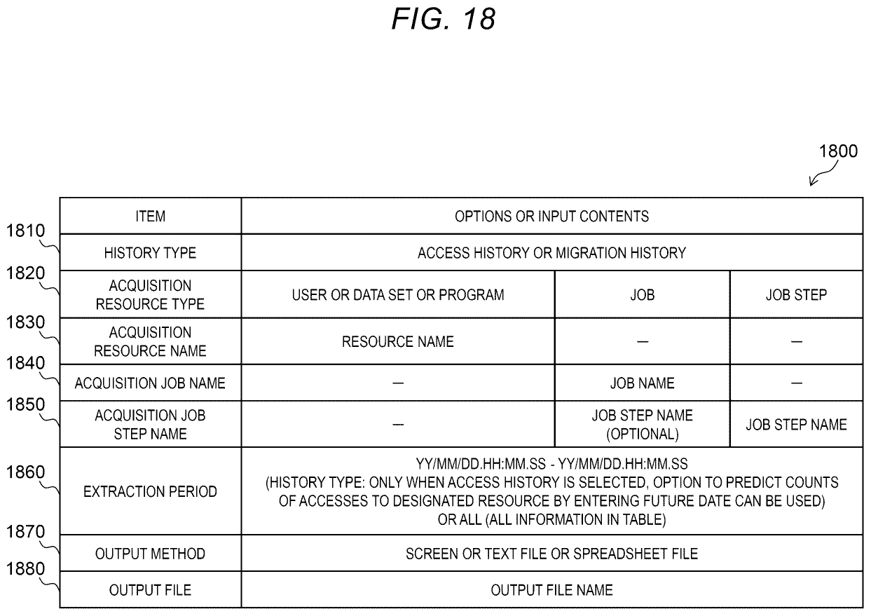

Next, processing related to a history reporter will be described. The history reporter is an example of the output unit 215, and outputs history (a migration history and/or an access history) information according to a report output instruction from the management terminal 130. In the report output instruction, information related to acquisition of a history, such as a resource for which a history is to be acquired and an output destination, is designated according to a designated item list 1800 shown in FIG. 18.

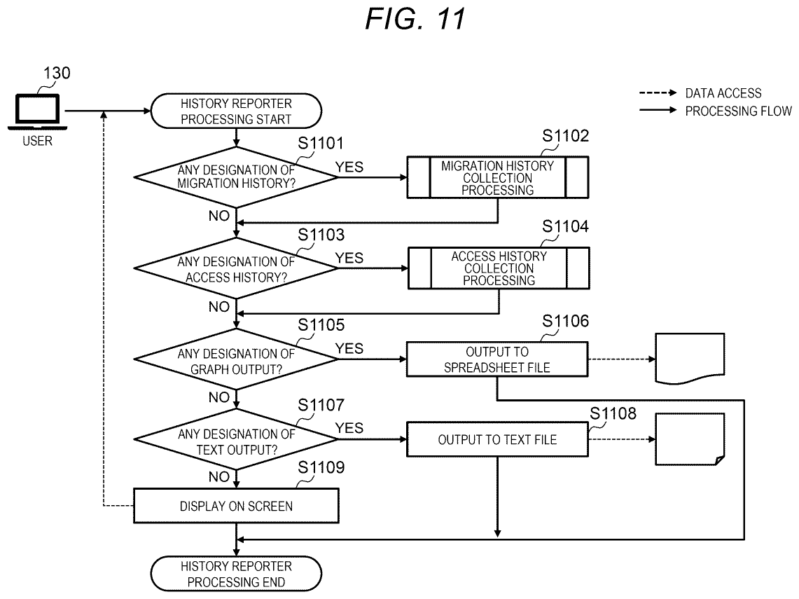

FIG. 11 is a diagram showing an example of a processing executed by the history reporter (history reporter processing).

In S1101, upon receiving a report output instruction from the management terminal 130, the open system 120 determines whether there is a designation of a migration history (for example, whether an input of a history type 1810 is a migration history). When the open system 120 determines that a migration history is designated, the processing proceeds to S1102, and when the open system 120 determines that no migration history is designated, the processing proceeds to S1103.

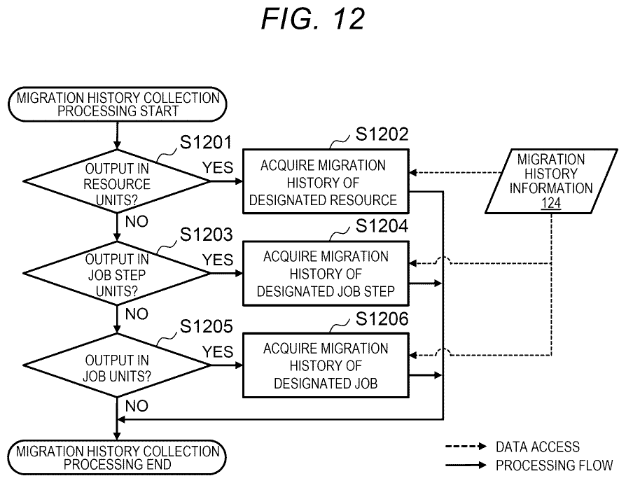

In S1102, the open system 120 performs migration history collection processing, and the processing proceeds to S1103. The migration history collection processing will be described later with reference to FIG. 12.

In S1103, the open system 120 determines whether an access history is designated (for example, whether the input of the history type 1810 is an access history). When the open system 120 determines that an access history is designated, the processing proceeds to S1104, and when the open system 120 determines that no access history is designated, the processing proceeds to S1105.

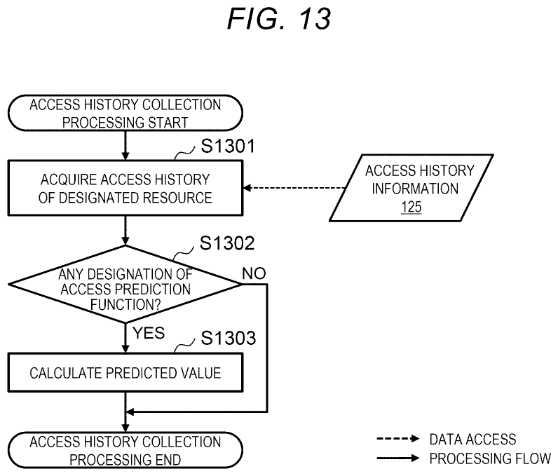

In S1104, the open system 120 performs access history collection processing, and the processing proceeds to S1105. The access history collection processing will be described later with reference to FIG. 13.

In S1105, the open system 120 determines whether a graph output is designated (for example, whether an input of an output method 1870 is a spreadsheet file). When the open system 120 determines that a graph output is designated, the processing proceeds to S1106, and when the open system 120 determines that a graph output is not designated, the processing proceeds to S1107.

In S1106, the open system 120 outputs the collected information to the spreadsheet file and ends the processing.

In S1107, the open system 120 determines whether a text output is designated (for example, whether an input of the output method 1870 is a text file). When the open system 120 determines that a text output is designated, the processing proceeds to S1108, and when the open system 120 determines that a text output is not designated, the processing proceeds to S1109.

In S1108, the open system 120 outputs the collected information to the text file, and ends the processing.

In S1109, the open system 120 displays the collected information on a screen of the management terminal 130, and ends the processing.

FIG. 12 is a diagram showing an example of the migration history collection processing.

In S1201, the open system 120 determines whether an output is designated in resource units (for example, whether an input of an acquisition resource type 1820 is a user, a data set, or a program). When the open system 120 determines that an output is designated in resource units, the processing proceeds to S1202, and when the open system 120 determines that no output is designated in resource units, the processing proceeds to S1203.

In S1202, the open system 120 acquires the migration history of the identified resource for a designated period from the migration history information 124, and ends the processing. For example, the open system 120 acquires, from the migration history information 124, a migration history of a resource name that matches a resource name input as an acquisition resource name 1830 and that is a migration history for a period input as an extraction period 1860.

In S1203, the open system 120 determines whether an output is designated in job step units (for example, whether an input of the acquisition resource type 1820 is a job step). When the open system 120 determines that the output is designated in job step units, the processing proceeds to S1204, and when the open system 120 determines that no output is designated in the job step units, the processing proceeds to S1205.

In S1204, the open system 120 acquires the migration history of the designated job step from the migration history information 124 for the designated period, and ends the processing. For example, the open system 120 acquires, from the migration history information 124, a migration history of resources (a user, a user group, a program, a storage pool, a volume, a data set, and the like) related to a job step of a job step name input as an acquisition job step name 1850 and that is a migration history for a period input as the extraction period 1860.

In S1205, the open system 120 determines whether an output is designated in job units (for example, whether an input of the acquisition resource type 1820 is a job). When the open system 120 determines that output is designated in job units, the processing proceeds to S1206, and when the open system 120 determines that no output is designated in the job units, the processing ends.

In S1206, the open system 120 acquires the migration history of the designated job from the migration history information 124 for the designated period, and ends the processing. For example, the open system 120 acquires, from the migration history information 124, a migration history of resources (a job, a job class, a user, a user group, or the like) related to a job of a job name input as an acquisition job name 1840, and that is a migration history for a period input as the extraction period 1860. When the job step name is input in the acquisition job step name 1850, the open system 120 acquires, from the migration history information 124, the migration history of the resource related to the job step of the job step name and that is a migration history for a period input as the extraction period 1860.

FIG. 13 is a diagram showing an example of the access history collection processing.

In S1301, the open system 120 acquires an access history of a designated resource from the access history information 125 for a designated period. For example, the open system 120 acquires, from the access history information 125, the migration history of a period input as the extraction period 1860, which is an access history of a resource name matching a resource name input as the resource name 1830.

In S1302, the open system 120 determines whether an access prediction function is designated (for example, a future date is input). When the open system 120 determines that the access prediction function is designated, the processing proceeds to S1303, and when the open system 120 determines that the access prediction function is not designated, the processing ends. The designation of the access prediction function may be set by an appropriate method and timing.

In S1303, the open system 120 calculates a predicted value (such as the access frequency of each resource) for a designated period based on the access history of a designated resource, and ends the processing. The calculation of the predicted value is performed by a known technique such as a prediction analysis model (for example, a linear regression model, a generalized linear model, or a neural network model). Additionally, the calculation of the predicted value may be performed by another computer different from the open system 120.

FIG. 14 is a diagram showing an example of the management information 113 and the management information 123.

The user registration record 113A stores information on the authority of the user in the main frame 110. For example, the user registration record 113A stores a record including information of a resource type, a resource name, authority, a password (PW), a group, and group authority. The data set registration record 113B stores information related to the authority of the data set in the main frame 110. For example, the data set registration record 113B stores a record including information of a resource type, a resource name, and authority. The volume registration record 113C stores information on the authority of the volume in the main frame 110. For example, the volume registration record 113C stores a record including information of a resource type, a resource name, and authority. The storage pool registration record 113D stores information related to the authority of the storage pool in the main frame 110. For example, the storage pool registration record 113D stores a record including information of a resource type, a resource name, and authority.

The job registration record 113E stores information related to the authority of the job in the main frame 110. For example, the job registration record 113E stores a record including information of a resource type, a resource name, and authority. The job class registration record 113F stores information on the authority of the job class in the main frame 110. For example, the job class registration record 113F stores a record including information of a resource type, a resource name, and authority. The program registration record 113G stores information related to the authority of the program in the main frame 110. For example, the program registration record 113G stores a record including information of a resource type, a resource name, and authority.

The registration record of the main frame 110 may include information on the registered user and the registration date and time. All registration records of the main frame 110 may be stored in the same storage device, or a part of the registration records may be stored in different storage devices.

The user registration record 123A stores information related to the authority of the user in the open system 120. Data items of the user registration record 123A are the same as the data items of the user registration record 113A. The data set registration record 123B stores information related to the authority of the data set in the open system 120. Data items of the data set registration record 123B are the same as the data items of the data set registration record 113B. The job registration record 123E stores information related to the authority of the job in the open system 120. Data items of the job registration record 123E are the same as the data items of the job registration record 113E. The program registration record 123G stores information related to the authority of the program in the open system 120. Data items of the program registration record 123G are the same as the data items of the program registration record 113G.

The registration record of the open system 120 may include information on the registered user and the registration date and time. All registration records of the open system 120 may be stored in the same storage device, or a part of the registration records may be stored in different storage devices.

FIG. 15 shows information indicating an example of authority type correspondence information (the authority type correspondence table 1500). The authority type correspondence table 1500 may be stored in the auxiliary storage device 230, may be stored in another computer, or may be included in the application program.

The authority type correspondence table 1500 includes a record indicating a correspondence relationship between the authority type in the main frame 110 and the authority type in the open system 120. According to the authority type correspondence table 1500, the format of the authority type of the main frame 110 is rewritten to the authority type of the open system 120. For example, when the authority in the main frame 110 is “NONE”, the authority of the open system 120 is rewritten to “None” according to a record 1510 when the open system 120 is migrated.

FIG. 16 is a diagram showing an example of aggregation correspondence information (the aggregation correspondence table 1600). The aggregation correspondence table 1600 may be stored in the auxiliary storage device 230, may be stored in another computer, or may be included in the application program.

The aggregation correspondence table 1600 includes a record in which authority to be applied is defined in correspondence with presence or absence of data set protection (authority), presence or absence of volume protection, and presence or absence of storage pool protection. For example, when the authority of the data set is “MEMBER”, the authority of the volume is “READ”, and the authority of the storage pool is “READ”, since there is the data set protection, the volume protection, and the storage pool protection, a correspondence relationship of the authority corresponds to a record 1620. When the authority of the data set, the volume, and the storage pool is migrated from the main frame 110 to the open system 120, the authority is aggregated to the authority “READ” of the volume according to the record 1620.

FIG. 17 is a diagram showing an example of an error code for identifying an error that occurs in the open system 120 (an error code table 1700). The error code table 1700 is a diagram showing a meaning of an error code.

FIG. 18 is a diagram showing an example of designated items which are items that can be designated in a history reporter (a designated item list 1800).

The designated item list 1800 includes items capable of designating conditions for acquiring a history (an access history and/or a migration history). As shown in the designated item list 1800, items of the history type 1810, the acquisition resource type 1820, the acquisition resource name 1830, the acquisition job name 1840, the acquisition job step name 1850, the extraction period 1860, the output method 1870, and an output file 1880 are provided. These items are designated (input) by the user via the management terminal 130.

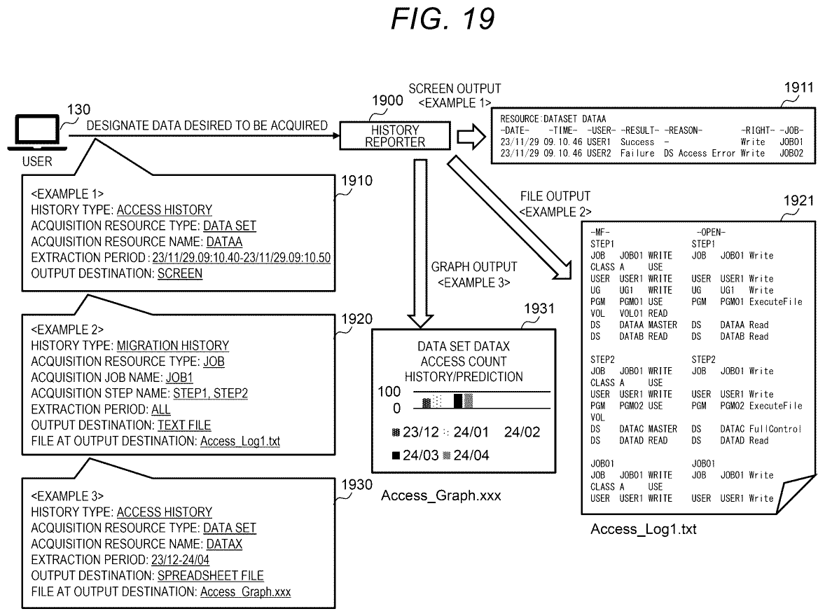

FIG. 19 is a diagram showing an example of a history reporter (a history reporter 1900).

The history reporter 1900 is, for example, an application program provided in the open system 120. When a history desired to be acquired by the user is designated via the management terminal 130, the history reporter 1900 extracts and outputs the history from the migration history information 124 and the access history information 125 according to the designation.

For example, when an item is designated as in a report output instruction 1910, the history reporter 1900 screen-outputs data 1911 obtained by extracting, from the access history information 125, an access history of the data set “DATAA” in a designated period “23/11/29.09:10.40-23/11/29.09:10.50”.

For example, when an item is designated as in a report output instruction 1920, the history reporter 1900 outputs, as a file, data 1921 obtained by extracting a migration history of all the periods of the job “JOB1” and the job steps “STEP1” and “STEP2” from the migration history information 124 with the file name “Access_Log1.txt”.

For example, when an item is designated as in a report output instruction 1930, since a future date is designated, the history reporter 1900 extracts an access history of the data set “DATAX” of a designated period “23/12-24/04” from the access history information 125 and outputs data 1931 including a graph indicating a result of calculating a predicted value as a file name “Access_Graph.xxx”.

According to the present embodiment, the program can be appropriately migrated from the main frame to the open system.

### (II) Appendices

The above-described embodiment includes, for example, the following contents.

In the above-described embodiment, the case in which the invention is applied to a computer system is described, and the invention is not limited thereto, and can be widely applied to various other systems, devices, methods, and programs.

In the above-described embodiment, the job step execution processing is called from the job execution processing, and the invention is not limited thereto. For example, the job step execution processing may be called in response to an operation from the management terminal 130.

In the above-described embodiment, a case is described in which, when management information of a resource for which migration is completed is changed, the main frame 110 transmits the management information before the change and the management information after the change to the open system 120, and the invention is not limited thereto. For example, the main frame 110 may transmit the management information before the change and the management information after the change or the management information after the change to the open system 120 for all the resources, and the open system 120 may reflect the change in the management information of the resources for which the migration is completed.

In the above-described embodiment, a part or all of the programs may be installed from a program source into a device such as a computer that implements the computer 200. The program source may be, for example, a program distribution server connected via a network or a computer-readable recording medium (for example, a non-transitory recording medium). In the above-described description, two or more programs may be implemented as one program, or one program may be implemented as two or more programs.

In the above-described embodiment, a configuration of each table is an example. One table may be divided into two or more tables, or all or some of two or more tables may be one table.

In the above-described embodiment, for convenience of description, the information related to the computer system is described using the tables, and a data structure is not limited to the table. The information related to the computer system may be expressed by a data structure other than a table, such as extensible markup language (XML), YAML ain't a markup language (YAML), a hash table, or a tree structure.

In the above-described embodiment, the screens illustrated and described are examples, and any design may be used as long as the same information is received.

In addition, in the above-described embodiment, the screens illustrated and described are examples, and any design may be used as long as information to be presented is the same.

In the above-described embodiment, an output of the information is not limited to the display on a display. The output of the information may be an audio output by a speaker, an output to a file, printing on a paper medium or the like by a printing device, projection on a screen or the like by a projector, or other modes.

In the above-described description, information such as a program, a table, and a file for implementing each function can be stored in a storage device such as a memory, a hard disk, and a solid state drive (SSD), or in a recording medium such as an IC card, an SD card, and a DVD.

The above-described embodiment has, for example, the following characteristic configurations.

(1)

A computer system in which programs for a plurality of job steps are sequentially migrated from a first computer system (for example, a main frame 110) to a second computer system (for example, the open system 120) different from the first computer system, the first computer system including management information (for example, the management information 123) to be used for access verification of a resource (a resource to be protected in batch processing, such as a user, a data set, a volume, a storage pool, a job, a job class, and a program) to be referred to in each of a plurality of job steps, and when executing any one of the plurality of job steps, configured to perform the access verification of the resource using the management information of the resource to be referred to in the job step, the computer system includes: an acquisition unit (for example, the acquisition unit 211, the computer 200) configured to acquire, from the first computer system, the management information to be used for the access verification of the resource to be referred to in the job step for which the program is migrated from the first computer system; a change unit (for example, the change unit 212, the computer 200) configured to change the management information acquired by the acquisition unit to management information usable by the second computer system; a storage unit (for example, the storage unit 213, the computer 200) configured to store the management information changed by the change unit; and a verification unit (for example, the verification unit 214, the computer 200) configured to perform the access verification of the resource using the management information of the resource to be referred to in the job step stored in the storage unit in response to a request for execution of the job step with which the program migrated from the first computer system is associated.

According to the above configuration, for example, since the access verification of the resource referred to in the job step to be executed by the second computer system during the program migration period can be implemented, the confidentiality equivalent to the system environment of the first computer system can be maintained. According to the above configuration, since the management information necessary for the access verification in the second computer system is acquired and the management information unnecessary for the access verification in the second computer system is not acquired, an inventory of the management information can be taken along with the migration of the program.

(2)

The first computer system includes management information (for example, the program registration record 113G) to be used for access verification of a program associated with each of the plurality of job steps, and when executing any job step of the plurality of job steps, performs the access verification of the program using the management information of the program associated with the job step, the acquisition unit acquires, when the program associated with the job step is migrated from the first computer system, the management information to be used for the access verification of the program from the first computer system (for example, see S602), the change unit changes the management information acquired by the acquisition unit to management information usable by the second computer system (for example, see S621), the storage unit stores the management information changed by the change unit (for example, see S621), and the verification unit performs, in response to a request for execution of the job step with which the program migrated from the first computer system is associated, the access verification of the program by using the management information of the program changed by the change unit (for example, see S905 and S906).

In the above configuration, for example, when the access verification of the program is executed in the first computer system, the management information of the program is acquired in the second computer system. According to the above configuration, the second computer system can execute the access verification of the program similarly to the first computer system, and can maintain confidentiality equivalent to a system environment of the first computer system.

(3)

The first computer system is provided with a job including one or a plurality of job steps, and includes management information (the user registration record 113A, the job registration record 113E, the job class registration record 113F, and the like) to be used for the access verification of the job, when executing the job, the first computer system requests the second computer system to execute the job if all programs associated with the job steps constituting the job are migrated to the second computer system (see, for example, S702 and S705), when the execution of the job is requested from the first computer system, the acquisition unit acquires, from the first computer system, the management information to be used for the access verification of the job (see, for example, S711), the change unit changes the management information of the job acquired by the acquisition unit into the management information usable by the second computer system (see, for example, S711), and the verification unit performs, in response to the request for execution of the job from the first computer system, the access verification of the job by using the management information of the job changed by the change unit (see, for example, S903 and S904).

In the above configuration, for example, when execution of a job is requested in the first computer system, the management information of the job is acquired in the second computer system. According to the above configuration, the second computer system can execute the access verification of the job in the same manner as the first computer system, and can maintain confidentiality equivalent to the system environment of the first computer system.

(4)

The first computer system is provided with a data set which is a set of data, a volume for storing the data set, and a storage pool including a plurality of volumes, and management information (for example, the data set registration record 113B) to be used for the access verification of the data set, management information (for example, the volume registration record 113C) to be used for the access verification of the volume, and management information (for example, the storage pool registration record 113D) to be used for the access verification of the storage pool, the acquisition unit acquires, from the first computer system, management information to be used for access verification of a data set to be referred to in a job step associated with the program migrated from the first computer system, management information to be used for access verification of a volume to be referred to in the job step, and management information to be used for access verification of a storage pool to be referred to in the job step (for example, see S811), and the change unit aggregates the management information of the data set, the management information of the volume, and the management information of the storage pool acquired by the acquisition unit into management information usable by the second computer system according to aggregation correspondence information (for example, the aggregation correspondence table 1600) in which an aggregation method is defined (for example, see S811).

In the above configuration, for example, even when the resources of the volume and the storage pool are not provided in the second computer system, the management information of the data set, the volume, and the storage pool is aggregated according to the aggregation correspondence information. According to the above configuration, the second computer system can execute the access verification of the resource in the same manner as the first computer system, and can maintain confidentiality equivalent to the system environment of the first computer system.

(5)

The storage unit stores migration history information (for example, the migration history information 124 and the migration history table 400) indicating that the management information of the resource is migrated when storing the management information to be used for the access verification of the resource to be referred to in the job step associated with the program migrated from the first computer system, and stores access history information (for example, the access history information 125 and the access history table 500) indicating an access to the resource when the job step is executed.

According to the above configuration, for example, when a setting change of the management information is required on a first computer system side during a program migration period, the user can easily investigate the influence of the setting change based on the migration history information and the access history information.

(6)

The verification unit performs, in response to a request for execution of a job step associated with the program migrated from the first computer system, the access verification of the resource by using the management information of the resource to be referred to in the job step stored in the storage unit, and when the access verification fails, extracts migration history information of the resource and access history information of the resource from information stored in the storage unit (see, for example, S822).

According to the above configuration, for example, when an error is detected in the access verification of the resource to be referred to in the job step, the migration history information and the access history information of the resource are extracted. According to the above configuration, the user can identify the cause of the error based on the migration history information and the access history information of the resource, and can reduce man-hours required to identify the cause of the error.

(7)

The computer system further includes an output unit (for example, the output unit 215 or the computer 200) that extracts, when receiving from a management terminal (for example, the management terminal 130) an instruction (for example, the report output instruction 1910, the report output instruction 1920, or the report output instruction 1930) designating a resource and/or a period for which a user needs to check, migration history information or access history information stored in the storage unit according to the instruction, and outputs the extracted information.

According to the above configuration, for example, the user can check desired migration history information and desired access history information.

(8)

The output unit outputs a result (for example, a spreadsheet file) of prediction of an access to a resource based on the access history information of the resource designated via a management terminal.

In the above configuration, since the access to the resource referred to in the job step associated with the program migrated to the second computer system is predicted, for example, the user can improve efficiency of an operation plan.

The above-described configurations may be appropriately changed, rearranged, combined, or omitted without departing from the scope of the invention.

Items included in the list in the format of “at least one of A, B, and C” can mean (A), (B), (C), (A and B), (A and C), (B and C), or (A, B, and C). Similarly, the items listed in the format of “at least one of A, B, or C” can mean (A), (B), (C), (A and B), (A and C), (B and C), or (A, B, and C).

1. A computer system in which programs for a plurality of job steps are sequentially migrated from a first computer system to a second computer system different from the first computer system, the first computer system including management information to be used for access verification of a resource to be referred to in each of a plurality of job steps, and when executing any one of the plurality of job steps, configured to perform the access verification of the resource using the management information of the resource to be referred to in the job step, the computer system comprising:
an acquisition unit configured to acquire, from the first computer system, the management information to be used for the access verification of the resource to be referred to in the job step for which the program is migrated from the first computer system;
a change unit configured to change the management information acquired by the acquisition unit into management information usable by the second computer system;
a storage unit configured to store the management information changed by the change unit; and
a verification unit configured to perform the access verification of the resource using the management information of the resource to be referred to in the job step stored in the storage unit in response to a request for execution of the job step with which the program migrated from the first computer system is associated.

2. The computer system according to claim 1, wherein
the first computer system includes management information to be used for access verification of a program associated with each of the plurality of job steps, and when executing any job step of the plurality of job steps, performs the access verification of the program using the management information of the program associated with the job step,
the acquisition unit acquires, when the program associated with the job step is migrated from the first computer system, the management information to be used for the access verification of the program from the first computer system,
the change unit changes the management information acquired by the acquisition unit into management information usable by the second computer system,
the storage unit stores the management information changed by the change unit, and
the verification unit performs, in response to a request for execution of the job step with which the program migrated from the first computer system is associated, the access verification of the program by using the management information of the program changed by the change unit.

3. The computer system according to claim 1, wherein
the first computer system is provided with a job including one or a plurality of job steps, and includes management information to be used for the access verification of the job,
when executing the job, the first computer system requests the second computer system to execute the job if all programs associated with the job steps constituting the job are migrated to the second computer system,
when the execution of the job is requested from the first computer system, the acquisition unit acquires, from the first computer system, the management information to be used for the access verification of the job,
the change unit changes the management information of the job acquired by the acquisition unit into the management information usable by the second computer system, and
the verification unit performs, in response to the request for execution of the job from the first computer system, the access verification of the job by using the management information of the job changed by the change unit.

4. The computer system according to claim 1, wherein
the first computer system is provided with a data set which is a set of data, a volume for storing the data set, and a storage pool including a plurality of volumes, and includes management information to be used for the access verification of the data set, management information to be used for the access verification of the volume, and management information to be used for the access verification of the storage pool,
the acquisition unit acquires, from the first computer system, management information to be used for access verification of a data set to be referred to in a job step associated with the program migrated from the first computer system, management information to be used for access verification of a volume to be referred to in the job step, and management information to be used for access verification of a storage pool to be referred to in the job step, and
the change unit aggregates the management information of the data set, the management information of the volume, and the management information of the storage pool acquired by the acquisition unit into management information usable by the second computer system according to aggregation correspondence information in which an aggregation method is defined.

5. The computer system according to claim 1, wherein
the storage unit stores migration history information indicating that the management information of the resource is migrated when storing the management information to be used for the access verification of the resource to be referred to in the job step associated with the program migrated from the first computer system, and stores access history information indicating an access to the resource when the job step is executed.

6. The computer system according to claim 5, wherein
the verification unit performs, in response to a request for execution of a job step associated with the program migrated from the first computer system, the access verification of the resource using the management information of the resource to be referred to in the job step stored in the storage unit, and when the access verification fails, extracts the migration history information of the resource and the access history information of the resource from information stored in the storage unit.

7. The computer system according to claim 5, further comprising:
an output unit configured to extract, when receiving from a management terminal an instruction designating a resource and/or a period for which a user needs to check, the migration history information or the access history information stored in the storage unit according to the instruction, and output the extracted information.

8. The computer system according to claim 7, wherein
the output unit outputs a result of prediction of an access to a resource based on the access history information of the resource designated via the management terminal.

9. An access verification method executed in a computer system in which programs for a plurality of job steps are sequentially migrated from a first computer system to a second computer system different from the first computer system, the first computer system including management information to be used for access verification of a resource to be referred to in each of a plurality of job steps, and when executing any one of the plurality of job steps, configured to perform the access verification of the resource using the management information of the resource to be referred to in the job step, the method comprising:
acquiring, by an acquisition unit, from the first computer system, the management information to be used for the access verification of the resource to be referred to in the job step for which the program is migrated from the first computer system;
changing, by a change unit, the management information acquired by the acquisition unit into management information usable by the second computer system;
storing, by a storage unit, the management information changed by the change unit; and
performing, by a verification unit, the access verification of the resource using the management information of the resource to be referred to in the job step stored in the storage unit in response to a request for execution of the job step with which the program migrated from the first computer system is associated.
